(19) United States
(12) Patent Application Publication
(10) Pub. No.: US 2025/0186296 A1
(43) Pub. Date: Jun. 12, 2025

(54) INTUITIVE ARTICULATED ARM-TYPE MASSAGE SYSTEM

(71) Applicant: Robotic Therapeutics FZ-LLC, Dubai (AE)

(72) Inventors: Maxim Yur'evich Gladilov, Dubai (AE); Denis Alekseevich Ledenkov, Dubai (AE)

(21) Appl. No.: 18/847,178

(22) PCT Filed: Feb. 20, 2023
(86) PCT No.: PCT/RU2023/050034

§ 371 Date: Sep. 13, 2024

(30) Foreign Application Priority Data
Mar. 14, 2022 (RU) 2022106564

(51) Int. Cl. A61H 15/00; A61H 7/00

(52) U.S. Cl. CPC A61H 15/0078; A61H 7/004; A61H 2015/0021; A61H 2015/005; A61H 2015/0071; A61H 2201/0165; A61H 2201/0192; A61H 2201/1246; A61H 2201/1659; A61H 2201/1676

(57) ABSTRACT

The group of inventions relates to physical therapy equipment and is intended for use in performing massage procedures. A physical therapy arrangement contains a control and adjustment part and, interconnected therewith, a working part comprising a robotic articulated actuator made up of movably interconnected links, and a damping suspension system including a support bracket with a working lever mounted to the lower end part thereof, one of the end regions of said working lever being provided with a sensitive contact element for applying a massage effect. The inventions make it possible to improve operational safety by allowing on-the-fly adjustment and limitation of the strength of the massage action as necessary.

### FIELD OF THE INVENTION

The proposed group of inventions relates to automated physical therapy equipment for performing health massage procedures, and specifically to intelligent stationary or mobile robotic machines equipped with contact articulated mechanisms with intuitively configured massage components.

### CONVENTIONAL ART

A massage robot is known from the conventional art (see CN109077907, cl. A61H7/00, publ. 2018 [1]).

A known massage robot [1] comprises a power supply unit, a control system and a massage element held by at least one articulated arm comprising at least two adaptive links movable relative to each other.

The essential feature of the massage robot under consideration is its structural design, including its external appearance, in the form of a humanoid object located on a movable supporting base.

Typically, a humanoid robot [1] moves along guides using a caterpillar actuator along a massage table on which the patient is located.

Direct massage effect is applied using the said massage element. The massage element is a portable physical therapy attachment with its active elements massaging the surface of the skin.

And the said articulated arm performing the function of the working part ensures control over the physical therapy procedure. Also, its parameters and features entered in the existing control system are observed, which comprehensively determines the functionality of this robotic device.

As indicated above, massage robot in [1] moves along a guide located at the bottom of the robot using a gear actuator, which may reduce the practical performance of the robot, since its reliability and operational safety require initial preparation of the installation surfaces and further monitoring of their operational condition and performing periodic maintenance.

An additional notable disadvantage of the technical solution in [1] is the mobility and versatility not provided for by the design, therefore, if the robot is moved from one point of use to another, it is necessary to dismantle the equipment, and then install and configure it at a new location to ensure correct operation in new conditions, and this will accordingly require the employment of additional funds and labor resources.

An intelligent massage robot is known from the prior art (see CN110123623, cl. A61H39/04, publ. 2019 [2]).

Known solution in [2] relates to the field of robotics, specifically to an intelligent rehabilitation massage robot.

Well-known intelligent massage robot in [2] comprises a movable base, a control system and a device for human interaction with the automatic machine.

The known robotic device includes a computer-controlled composite massage articulated arm that can move in several planes, and the said device for human interaction with the automatic system has a control unit, a processor and an information display device.

It should be noted that the body of the intelligent robot is mounted on a movable base, and movement is performed using adaptive roller mechanisms.

The known massage robot in [2] is rather functional, highly versatile and practical, since it can be used on various surfaces, easily and freely transported from one place of use to another, and when putting into operation, requires no adjustment or adaptation of equipment.

However, the device in [2] has some notable disadvantages that should be mentioned below.

The articulated arm used for massage, as noted above, has the ability to move in several planes and this is ensured by the fact that it comprises three movably interconnected adaptive links. However, the described embodiment is not able to guarantee safety of the procedure, since during the massage, when moving, the peripheral parts of links can touch the patient's skin, which can lead to injuries.

Another technical deficiency is the unfinished/insufficiently considered ergonomic parameters, which, in particular, do not ensure compliance with the adaptive unified approach to conducting physical therapy procedures, but require periodic human intervention, for example, to replace the massage attachment or a programmatic change in parameters and/or operating mode of the working parts of this massage robot.

The closest analogue of the proposed group of inventions is the massage robot, known from CN210277652, cl. A61H7/00, publ. 2020 [3].

The known solution is used as a physical therapy device configured for automated controlled application of a medical massage effect.

The known massage robot has a control system and a working part that interacts with it. In this case, the working part has a robotic articulated actuator, which has several moving components; in addition, it is possible to adjust the strength of the massage action.

According to the design of massage robot in [3], the robotic articulated actuator is mounted by means of an intermediate element on a movable supporting body, and the said components of the arm actuator are movably interconnected mechanical levers, the outermost of which has the ability to make a massage contact, for which it is equipped with an adaptive massage attachment.

In accordance with the operating mode of massage robot in [3], threshold values of massage action are set by means of the control unit. The strength and speed of the massage are regulated, taking into account the previously studied anatomical features of each particular patient.

It should be noted that the existing ability to adjust the strength of the massage action cannot ensure the efficiency or safety of the therapeutic procedure. For example, during massage, an involuntary/unforeseen reaction of the body may occur, such as reflex reactions, as well as spasms or cramps, unstable/unsteady responses, which may incorrectly affect the strength of the massage action and be the cause of possible inaction or, conversely, excessive action with a risk of injury.

An additional disadvantage is the possible inaccuracies in the positional operation of the arm actuator, caused by the fact that the installation of the robot and its preparation for applying a physical therapy effect is carried out mainly in manual mode with the aid of an operator, who periodically adjusts its operation, changing the installation area and settings of the control system, which can lead to a shift in the position of the massage instrument and to a subsequent search for its set spatial position to be able to apply a massage effect.

### SUMMARY OF THE INVENTION

The technical problem of the proposed group of inventions is the creation of an arm-type physical therapy robot with high technical and operational characteristics, capable of applying a therapeutic massage effect in automatic mode with the possibility of adaptive sensitivity control of the strength of the massage action.

The technical result of the proposed group of inventions is the implementation of the purpose of creating the said sensitive automatic massage arrangement, with its operation ensuring high efficiency and safety of the procedure by means of the possibility of on-the-fly adjustment and limitation of the strength of the massage action as necessary.

The specified technical result, which solves the given technical problem, is achieved as a result of the fact that the articulated arm-type contact physical therapy arrangement comprises a control and adjustment part and, interconnected therewith, a working part, including a robotic articulated actuator, a damping suspension system and a sensitive contact element for applying a massage effect, wherein the robotic articulated actuator is made in the form of a composite part consisting of movably interconnected links to form non-coaxial transitions in the specified connection points, the damping suspension system comprises a support bracket fixed to the free end part of the link with a working lever mounted to the lower end part thereof with the possibility of rolling, one of the end regions of which is equipped with the said sensitive contact element for applying a massage effect, and another region of the working lever is connected to the docking part of the support bracket by means of a connecting module with an elastic element, wherein the location of the said sensitive contact element is selected so that, firstly, the rolling axis of the working lever is preferably parallel to the plane formed by the area of contact of the surface of the sensitive contact element with the surface of the user's body, and secondly, so that the said area of contact is located outside the plane formed by the rolling axis of the working lever and the conditional perpendicular to the plane formed by the contact area.

Also, the specified technical result solving the given technical problem is achieved due to the fact that the arm-type contact physical therapy arrangement comprises a control and adjustment part and, interconnected therewith, a working part, including a robotic articulated actuator, a damping suspension system and a sensitive contact element for applying a massage effect, wherein the robotic articulated actuator is made in the form of a composite part consisting of movably interconnected links with the formation of non-coaxial transitions in the specified connection points, the damping suspension system is made in the form of hinged mechanism, at least a four-component hinged mechanism, the upper part of which is made in the form of a rigid link on the free end part of the respective upper unit, and the lower part is made in the form of a respective movable lower unit, the end part of which is provided with the said sensitive contact element, wherein the specified upper and lower units are connected to each other by two inclined jumpers with a connecting module with an elastic element located in-between, one part of which fixed on the upper unit, and the other is mechanically connected to the lower unit, wherein the location of the said sensitive contact element is selected so that the plane formed by the area of contact of the surface of the sensitive contact element with the surface of the user's body is predominantly perpendicular to the tangent to the trajectory of movement of the lower unit in the middle part of the permissible movement range.

In addition, the specified technical result, which solves the stated technical problem, is achieved due to the fact that the arm-type contact physical therapy arrangement comprises a control and adjustment part and, interconnected therewith, a working part, including a robotic articulated actuator, a damping suspension system and a sensitive contact element for applying a massage effect, wherein the robotic articulated actuator is made in the form of a composite part consisting of movably interconnected links with the formation of non-coaxial transitions in the specified connection points, the damping suspension system consists of a support bracket mounted to the free end part of the link, comprising a linear vertically oriented guide, on which a carriage is mounted with the possibility of movement, the movement of which in the upper direction is limited by a connecting module with an elastic element mounted on the connecting part of the support bracket, wherein the carriage is provided with a retaining unit with the said sensitive contact element mounted thereon, the location of which is selected so that the plane formed by the contact part of the surface of the sensitive contact element with the surface of the user's body is predominantly perpendicular to the linear guide.

The embodiments of the declared arm-type contact physical therapy arrangements proposed above, taking into account their characteristics and technical features, form a set of features sufficient to achieve the specified technical result, consisting in the implementation of the purpose of creating the said sensitive automatic massage arrangement, the functioning of which ensures high efficiency and safety of the procedure by means of the possibility of on-the-fly adjustment and limitation of the strength of the massage action as necessary and, in fact, for solving the urgent technical problem of obtaining a physiotherapeutic arm-type robot with high technical and operational characteristics, capable of applying a therapeutic massage effect in automatic mode with the possibility of adaptive control of the sensitivity of the strength of the massage action.

Additional features and advantages of the invention are described in the following disclosure and proved by the actual practice of the invention. These advantages and improvements can be achieved by intelligent agents constructed and trained following the claimed method, precisely following the disclosure, along with the accompanying claims and drawings.

### BRIEF DESCRIPTION OF THE ATTACHED FIGURES

The accompanying drawings, which are attached to provide a further understanding of the invention and are incorporated in and constitute a part of this specification, illustrate embodiments of the invention and, together with the description, serve to explain the principles of the invention. In the drawings:

FIG. 1 shows a general view of the proposed massage system;

FIG. 2 shows an embodiment of the massage system according to the first embodiment (embodiment 1) using a bracket for the suspension system;

FIG. 3 shows an embodiment of the massage system according to the second embodiment (embodiment 2) using a hinged four-component mechanism for the suspension system;

FIG. 4 shows an embodiment of the massage system according to the third embodiment (embodiment 3) using a support bracket with a linear guide for the suspension system;

FIG. 5 shows an embodiment of the massage system using a spring as an elastic element of the suspension system;

FIG. 6 shows an embodiment of the massage system using a pneumatic cylinder as an elastic element of the suspension system;

FIG. 7 shows a sensitive contact element for applying a massage effect in the form of compression microvibration.

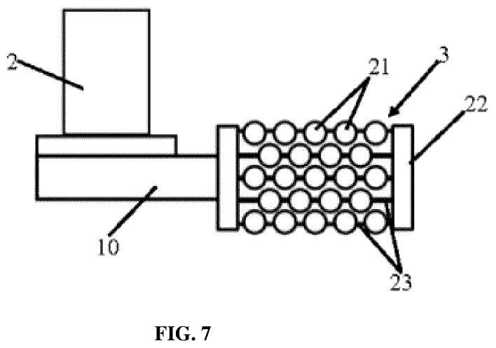

### DETAILED DESCRIPTION OF EMBODIMENTS OF THE INVENTION

Reference will now be made in detail to the preferred embodiments of the present invention, examples of which are illustrated in the accompanying drawings.

The proposed group of inventions is clarified by specific examples of implementation and realization, which, however, are not the only possible ones, but clearly demonstrate the achievement of the specified technical result by the indicated sets of essential features, as well as the solution of the existing technical problem.

The listed figures show the following parts and elements of the proposed arm-type contact physical therapy arrangement (embodiments):
1—control and adjustment part;
2—articulated actuator;
3—sensitive contact element for applying a massage effect;
4—damping suspension system;
5—articulated drive link;
6—non-coaxial transitions;
7—wheeled movement devices;
8—support bracket;
9—connecting module with elastic element;
10—working lever;
11—axis of rotation;
12—upper unit;
13—four-component hinge mechanism;
14—lower unit;
15—jumpers;
16—massage rollers;
17—linear guide;
18—carriage;
19—retaining unit;
20—screw;
21—rotating massage rollers;
22 v—rotor;
23—roller rotation axes;
24—working part;
25—control panel.

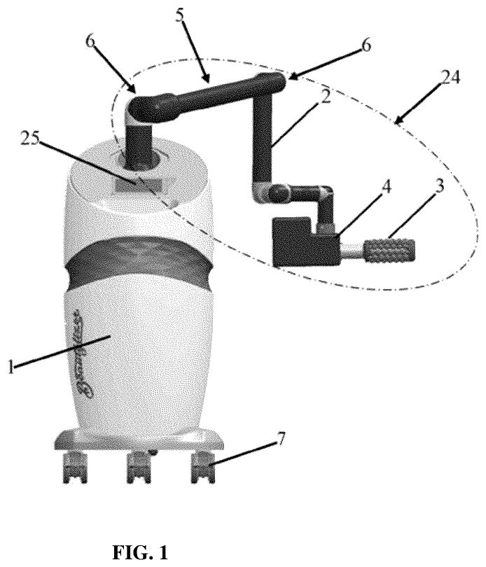

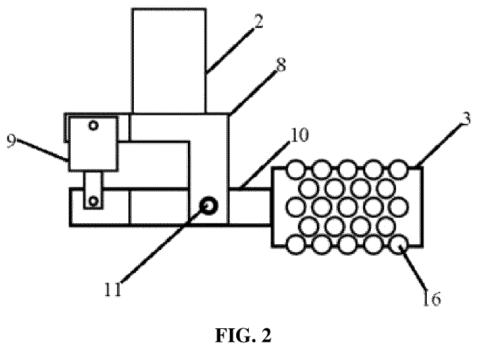

Thus, according to the first embodiment of the arm-type contact physical therapy arrangement (see FIG. 1, FIG. 2) it comprises working part 24 and control and adjustment part 1.

Working part 24 comprises robotic articulated actuator 2, damping suspension system 4, and also sensitive contact element 3 for applying a massage effect, containing massage rollers 16.

Robotic articulated actuator 2 is made in the form of a composite part consisting of movably interconnected links 5 with the formation of non-coaxial transitions 6 at the designated connection points.

Damping suspension system 4 comprises support bracket 8 mounted on the free end part of link 5. Working lever 10 is mounted on the lower end part of support bracket 8 with the possibility of rolling.

One of the end regions of working lever 10 is equipped with the said sensitive contact element 3 for applying a massage effect, and another end region is connected to the opposite part of support bracket 8 by means of connecting module with an elastic element 9.

In this case, the location of said sensitive contact element 3 is selected so that, firstly, rolling (rotation) axis 11 of working lever 10 is predominantly parallel to the plane formed by the contact area of the surface of sensitive contact element 3 with the surface of the user's body, and secondly, so that the said contact area is located outside the plane formed by rolling axis 11 of working lever 10 and the conditional perpendicular to the plane formed by the contact area.

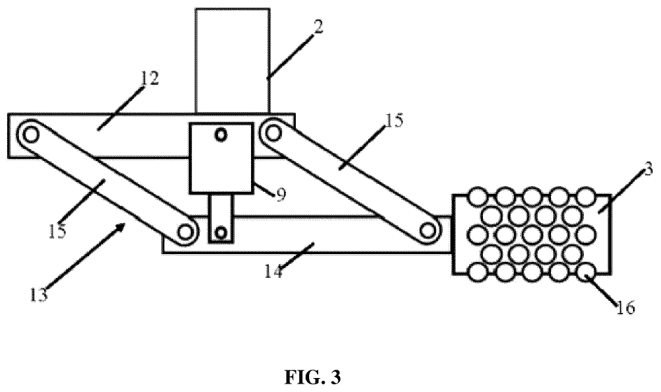

According to the second embodiment of the arm-type contact physical therapy arrangement (see FIG. 1, FIG. 3), it contains working part 24 and control and adjustment part 1.

Working part 24 comprises robotic articulated actuator 2, damping suspension system 4, and also sensitive contact element 3 for applying a massage effect, containing massage rollers 16.

Robotic articulated actuator 2 is made in the form of a composite part consisting of movably interconnected links 5 with the formation of non-coaxial transitions 6 at the designated connection points.

The damping suspension system is made in the form of a hinged mechanism, at least four-component hinged mechanism 13. The upper part of this mechanism is made in the form of rigid link 5 on the free end part of respective upper unit 12, and its lower part is made in the form of respective movable lower unit 14.

The end part of lower unit 14 is provided with said sensitive contact element 3.

Said upper 12 and lower 14 units have approximately the same length and are interconnected by two inclined jumpers 15 of approximately the same length. Connecting module with elastic element 9 is located between said jumpers 15, wherein one upper side of said module 19 is fixed to upper unit 12, and one lower side of said module 19 is fixed to lower unit 14.

The location of said sensitive contact element 3 for applying a massage effect is selected so that the plane formed by the area of contact of the surface of sensitive contact element 3 with the surface of the user's body is predominantly perpendicular to the tangent to the trajectory of movement of lower unit 14 in the middle part of the permissible movement range.

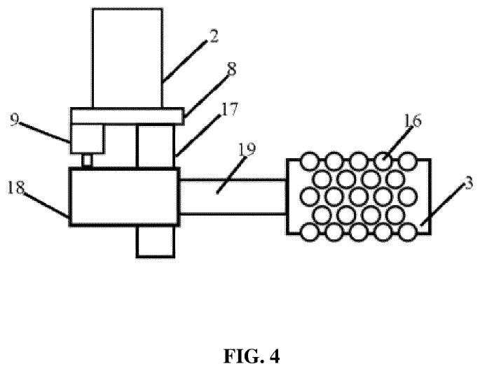

According to the third embodiment of the arm-type contact physical therapy arrangement (see FIG. 1, FIG. 4), it contains working part 24 and control and adjustment part 1.

Working part 24 comprises robotic articulated actuator 2, damping suspension system 4, and also sensitive contact element 3 for applying a massage effect, containing massage rollers 16.

Robotic articulated actuator 2 is made in the form of a composite part consisting of movably interconnected links 5 with the formation of non-coaxial transitions 6 at the designated connection points.

In this case, the damping suspension system comprises a support bracket secured to the free end part of link 5, containing a linear vertically oriented guide 17, on which carriage 18 is mounted with the possibility of movement, the movement of which in the upper direction is limited by connecting module with elastic element 9, mounted opposite said linear guide 17 on support bracket 8.

Carriage 18 is provided with retaining unit 19 with said sensitive contact element 3 installed thereon, the location of which is selected so that the plane formed by the area of contact of the surface of sensitive contact element 3 with the surface of the user's body is predominantly perpendicular to linear guide 17.

It should be noted that the purpose of the subsequent description of the proposed embodiments of the invention is not to limit them to specific embodiments, but, on the contrary, cover all possible additions that do not go beyond the scope of the presented claims of the invention.

Thus, the proposed group of embodiments can be implemented in the following way.

The proposed arm-type contact physical therapy arrangement, as noted above, is equipped with control and adjustment part 1 and working part 24, including articulated actuator 2, which is in turn equipped with sensitive contact element 3 for applying an immediate direct massage effect. In this case, it should be noted that sensitive contact element 3 used is connected to articulated 2 using damping suspension system 4, which in particular ensures the possibility of moving sensitive contact element 3 primarily in a perpendicular direction relative to the surface of the user's body.

Connecting module with elastic element 9 used in damping suspension system 4, which is in a pre-stressed state, is essentially an intermediate element that transmits the force from articulated actuator 2 to sensitive contact element 3, which determines the conditions movement such that when the reaction force of the support from side of the user's body exceeds a set value, sensitive contact element 3 moves under the action of the above force.

This ensures that the force acting on the user from sensitive contact element 3 is limited.

A system similar to the system known from the information source U.S. Pat. No. 10,434,658, publ. 2019 [4],can be used as control and adjustment part 1. Such a used system, known from [4], includes an image processing module and a motion controller. The image processing module processes images to determine the location of the area (spot) on the user's body where a massage effect will be applied. The motion controller controls articulated actuator 2 to perform a massage procedure at the identified massage action site.

A robotic arm of one of the models “PULSE 75” or “PULSE 90” manufactured by Rozum Robotics, Minsk (Belarus), can be used as articulated actuator 2, see (https://rozum.com/robotic-arm/#about [5]). These robotic arms are currently generally available and have 6 degrees of freedom, which will allow sensitive contact element 3 to be moved to virtually any given point within a given area of space and to be oriented at any angle in the specified area.

A massage attachment, the design of which is similar to the attachment known from WO 2020148624, publ. 2020 [6], can be used as sensitive contact element 3 for applying a massage effect.

It should be noted that damping suspension system 4, according to the author's concept, is designed to reduce the accompanying dynamic loads, which allows for applying a steady, smooth massage effect with a minimal risk of injury.

Connecting module with elastic element 9 of damping suspension system 4 used in the proposed arrangement provides a mechanical connection between sensitive contact element 3 and articulated actuator 2, wherein the length of connecting module with elastic element 9 changes under the action of force applied by the user on sensitive contact element 3, which is mechanically connected to connecting module with elastic element 9.

The movement of sensitive contact element 3 for applying a massage effect away from the surface of the user's body with an increase in the said force is determined by the rigidity coefficient of connecting module with elastic element 9 and the parameters of its mechanical connection with sensitive contact element 3, and the reverse movement when the said force is decreased is ensured by the elastic properties of connecting module with elastic element 9.

In the first embodiment of the contact physical therapy arrangement (see FIG. 1, FIG. 2), the damping suspension system comprises support bracket 8, which is fixed to articulated actuator 2, or rather to its end link 5, as well as working lever 10 with sensitive contact element 3 for applying a massage effect mounted thereon. In this case, rolling axis 11 of working lever 10 is mounted directly on support bracket 8.

Connecting module with elastic element 9 additionally connects working lever 10 and support bracket 8.

Sensitive contact element 3 is mounted such that its working massage surface is located relative to support bracket 8 so that rolling axis 11 of working lever 10 is predominantly parallel to the plane formed by the contact part of sensitive contact element 3 and the surface of the patient's body, whereas the said contact part does not intersect the plane formed by rolling axis 11 of working lever 10 and the conditional perpendicular to the plane formed by the said contact part. When sensitive contact element 3 contacts the surface of the patient's body, the reaction force of the support is transmitted through working lever 10, swinging on rolling axis 11, to connecting module with elastic element 9, which is pre-stressed. If the force acting on connecting module with elastic element 9 exceeds the value set by pre-stressing, then the length of the said module will increase, which will lead to the movement of working lever 10 and, accordingly, the element of sensitive contact element 3, which, in turn, will result in a decrease of the reaction force of the support towards the contact element 3 from the side of the patient's body surface.

In this case, control and adjustment part 1 sets and maintains such a configuration of articulated actuator 2 during the massage, that when working lever 10 rolls under the action of the reaction force of the support from the side of the user's body, sensitive contact element 3 moves in a direction close to perpendicular to the surface of the user's body in the area (spot) of contact. This configuration of articulated actuator 2 is achieved when working lever 10 and rolling axis 11 are practically parallel to the surface of the patient's body in the contact area.

In the second embodiment of the proposed contact physical therapy arrangement (see FIG. 1, FIG. 3), damping suspension system 4 contains a hinged four-component mechanism 13 with its design forming a conditional parallelogram. The design of four-component mechanism 13 contains upper fixed unit 12, which is secured to end link 5 of articulated actuator 2, and lower movable unit 14 with sensitive contact element 3 for applying a massage effect mounted on the end part thereof.

Lower movable unit 14 and upper fixed unit 12 have approximately the same length and are interconnected by means of two inclined crossbars 15 of approximately the same length, in this case rocker arms, with connecting module with an elastic element 9 installed in-between, one (upper) part of which is fixed to upper fixed unit 12, and the other (lower) part of which is fixed to lower movable unit 14.

Resulting damping suspension system 4 ensures parallel movement of sensitive contact element 3. When sensitive contact element 3 contacts the surface of the patient's body, the reaction force of the support through sensitive contact element 3 acts on lower movable unit 14. In this case, the mechanical connection of lower movable unit 14 with upper fixed unit 12 by means of jumpers 15 reduces the movement of lower movable unit 14 to a plane-parallel transfer, during which the respective distance between units 14 and 12 changes. In this case, force acts on connecting module with the elastic element 9, which is mechanically connected to units 14 and 12 and is pre-stressed. If the force acting on connecting module with the elastic element 9 exceeds the value set by pre-stressing, then the length of this module will decrease, which will lead to the movement of lower movable unit 14 and, accordingly, sensitive contact element 3, which, in turn, will result in a decrease in the reaction force of the support towards sensitive contact element 3 from the side of the patient's body surface.

Sensitive contact element 3 is mounted such that its working massage surface is located relative to lower movable unit 14 so that the plane formed by the part (spot) of contact of sensitive contact element 3 and the surface of the patient's body is predominantly perpendicular to the tangent to the trajectory of movement of lower movable unit 14 in the middle of the permissible movement range. In this case, control and adjustment part 1 sets and maintains such a configuration of articulated actuator 2 during the massage, that the movement of sensitive contact element 3 during the movement of lower unit 14 under the action of the reaction force of the support from the side of user's body occurs in a direction close to perpendicular to the surface of the user's body in the area (spot) of contact. This configuration of articulated actuator 2 is achieved when lower movable unit 14 and its rolling axes are parallel to the surface of the patient's body in the contact area, and the angle between lower movable unit 14 and jumpers 15 is small, for example, less than 30 degrees.

In the third embodiment of the proposed contact physical therapy arrangement (see FIG. 1, FIG. 4), the damping suspension system comprises support bracket 8 mounted on the end link of articulated actuator 2 and at least one linear guide 17 mounted on support bracket 8 itself. There is also carriage 18, which has the ability to move in a plane-parallel direction along linear guide 17. Sensitive contact element 3 is attached to carriage 18 using retaining unit 19. In this case, connecting module with the elastic element 9 directly connects carriage 18 and support bracket 8. When sensitive contact element 3 contacts the surface of the patient's body, the reaction force of the support through this element 3 acts on retaining unit 19, and through it on carriage 19, which moves along linear guide 17 fixed on support bracket 8. In this case, force acts on connecting module with elastic element 9, which is mechanically connected to linear guide 17 and support bracket 8 and is pre-stressed. If the force acting on connecting module with elastic element 9 exceeds the value set by pre-stressing, then the length of this module will decrease, which will lead to the movement of carriage 18 and, accordingly, retaining unit 19 fixed thereto with sensitive contact element 3, which, in turn, will result in a decrease in the reaction force of the support towards said element 3 from the side of the patient's body surface.

Proposed damping suspension system 4 ensures parallel movement of sensitive contact element 3.

Sensitive contact element 3 is installed such that its working massage surface is located relative to retaining unit 19 of carriage 18 so that the plane formed by the part (spot) of contact of sensitive contact element 3 and the surface of the patient's body is predominantly perpendicular to linear guide 17.

In this case, control and adjustment part 1 sets the necessary configuration of articulated actuator 2 so that sensitive contact element 3 is oriented relative to the surface of the user's body such that the movements of carriage 18 along linear guide 17 occur in a direction close to perpendicular relative to the surface of the user's body in the area (spot) of contact. This configuration of articulated actuator 2 is achieved when linear guide 17 is perpendicular to the surface of the patient's body in the contact area.

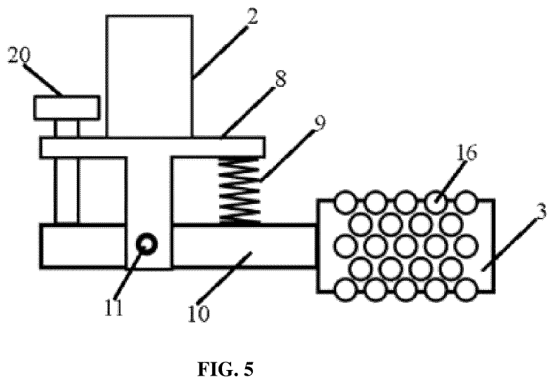

Connecting module with the elastic element 9 can be made on the basis of a spring loaded to a given value (see FIG. 5). For example, when a conventional lever suspension system is used (embodiment 1, FIG. 1, FIG. 2), then connecting module with elastic element 9, made in the form of a spring, which connects support bracket 8 and working lever 10, can comprise of a cylindrical helical compression spring. In this case, preliminary loading (compression) can be performed using screw 20 (see FIG. 5). Screw 12 provides a given spring compression degree and can limit the angle of swing of working lever 10, and therefore limits the movement range of sensitive contact element 3.

It should be noted that the compression force of element 9, in particular, made in the form of a spring in the absence of contact of sensitive contact element 3 with the surface of the patient's body, is determined by the characteristics of the spring itself and, if necessary, by the position of screw 20.

If the pressing force of sensitive contact element 3 exceeds the set value, and consequently the reaction force of the support from the side also exceeds the set value, which can be calculated using known methods, the force of action on connecting module with elastic element 9, in particular, made in the form of a spring from the side of working lever 10, will exceed the elastic force of element 9 and working lever 10 will start moving, compressing the spring (element 9) and moving sensitive contact element 3 away from the surface of the user's body, which will reduce the reaction force of the support, bringing damping suspension system 4 to a new balanced state and thereby limiting the reaction force of the support.

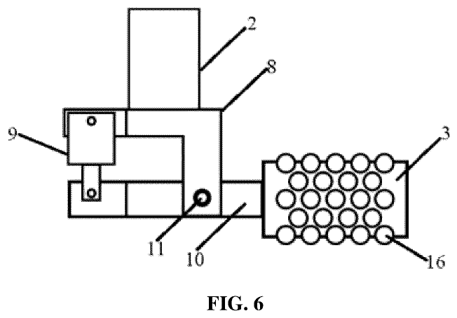

In another embodiment, connecting module with the elastic element 9 can be made on the basis of a pneumatic cylinder (see in particular FIG. 6), with a set value of pressure therein. Connecting module with elastic element 9 based on a pneumatic cylinder operates similarly to the described embodiment with element 9 implemented as a spring loaded to a set value. In this case, the pressure in such a pneumatic cylinder (connecting module with elastic element 9) during the massage can be regulated by control and adjustment part 1 by supplying control signals to pressure regulators, valves or other elements through which a compressor and/or receiver and the atmosphere are connected to the pneumatic cylinder (connecting module with elastic element 9). The pneumatic cylinder used (connecting module with elastic element 9) may include a piston limit stop.

Thus, the use of a damping suspension system according to the presented embodiments of the inventions, ensures the efficiency of massage and increases user safety, preventing dangerous forces from acting on the user. In addition, user safety is ensured in the event of failures in the operation of the electromechanical components of the device.

According to one of the embodiments, a massage attachment containing rotating rotor 22 connected to an electric motor with multiple axes 23 on which rotating massage rollers 21 are located can be used as sensitive contact element 3. This attachment is used for compression microvibration massage.

It is important to note that control and adjustment part 1 may contain a control unit for sensitive contact element 3 and may be connected thereto using electrical cables built into or routed inside articulated actuator 2.

Control and adjustment part 1 receives and processes the user's image, and then determines the area on the user's body to be massaged. Then, control and adjustment part 1 controls the movement of articulated actuator 2, which brings sensitive contact element 3 to the area of action and presses it against the user's body with a given force, orienting it in one of the above ways. The above impact force is determined by the parameters of connecting module with elastic element 9 and the current position of sensitive contact element 3 relative to the user's body. Additionally, the above action force can be controlled by moving sensitive contact element 3 along the normal to the surface of the contact area based on the readings of the force and/or displacement sensors built into sensitive contact element 3.

In one of the operating options, rotor 22 of sensitive contact element 3 is rotated by an electric motor. As a result, rotating massage rollers 21 located on numerous rotation axes 23 of rotor 22, when in contact with the surface of the user's body, exhibit a massage effect in the form of compression microvibration, affecting the skin and subcutaneous tissues to restore blood circulation, increase resistance and elasticity of connective tissue.

If the user's body position changes during the massage in the presence of a movement component normal to the surface of the body in the contact area, two options are possible.

In the first option, when the surface of the user's body moves away from sensitive contact element 3, the pressing force created by connecting module with the elastic element 9 moves sensitive contact element 3, pressing it against the surface of the user's body, which makes it possible to compensate for body movement and continue the massage.

In the second option, when the surface of the user's body moves towards sensitive contact element 3, the normal reaction force of the support from the side of the body moves sensitive contact element 3 due to a change in the length of the elastic connection created by connecting module with the elastic element 9. In this case, the pressing force of sensitive contact element 3 acting on the surface of the body changes within the limits of the specified values determined by the parameters of module with elastic element 9. This protects the user from unsafe mechanical impact and makes it possible to compensate for body movement and plan a massage.

The proposed group of inventions (embodiments) can be successfully used for therapeutic and preventive purposes, as well as for improving the health of the body. This group ensures high efficiency and safety, and allows for applying a massage effect in a fully automatic mode. The proposed physical therapy arrangement can be used as a medicine for the treatment of joints, muscle contractures and scars, and can be used by athletes as a means of improving and maintaining physical fitness, preparing for participation in sports events, and also as a rehabilitation tool for recovery after injuries and illnesses. In addition, the proposed group can be used to treat diseases of the lymphatic system, stimulate the feet, activate blood circulation, treat venous insufficiency and thrombophlebitis.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

1. (canceled)

2. (canceled)

3. (canceled)

4. An arm-type contact massage device, comprising:
a control and adjustment part; and
a working part interconnected to the control and adjustment part,
wherein the working part includes
a robotic articulated actuator,
a damping suspension system, and
a sensitive contact element for a massage effect,
wherein the robotic articulated actuator includes movably interconnected links with non-coaxial transitions in their connection points,
wherein the damping suspension system includes a support bracket mounted on a free end part of the interconnected links, and has a working lever mounted to a lower end of the damping suspension system, and
wherein the working lever is configured for rolling,
wherein one end regions of the working lever includes the sensitive contact element, and
wherein another region of the working lever is connected to a docking part of the support bracket by a connecting module with an elastic element,
wherein the sensitive contact element is located so that
(1) a rolling axis of the working lever is substantially parallel to a plane formed by a contact area of user's body and the sensitive contact element, and
(2) the contact area is located outside the plane formed by the rolling axis and a line perpendicular to a plane of the contact area.

5. The massage device of claim 4, wherein the sensitive contact element includes a plurality of spherical elements for vibrocompression massage.

6. An arm-type contact massage device, comprising:
a control and adjustment part; and
a working part interconnected to the control and adjustment part,
wherein the working part includes
a robotic articulated actuator,
a damping suspension system, and
a sensitive contact element for a massage effect,
wherein the robotic articulated actuator includes movably interconnected links with non-coaxial transitions in their connection points,
wherein the damping suspension system includes a four-component hinged mechanism forming a conditional parallelogram,
wherein an upper part of the hinged mechanism is a rigid link mounted on a free end part of the interconnected links, and
a lower part of the hinged mechanism that is movable and includes the sensitive contact element mounted on its end,
wherein the upper and lower parts are interconnected by two inclined jumpers having an elastic element located in-between,
the elastic element having one part fixed on the upper unit, and
the elastic element having another part coupled to the lower unit,
wherein the sensitive contact element is located so that a plane formed by an area of contact of the sensitive contact element with a surface of the user's body is substantially perpendicular to a direction of movement of the lower unit in a middle part of its permissible movement range.

7. The massage device of claim 6, wherein the sensitive contact element includes a plurality of spherical elements for vibrocompression massage.

8. An arm-type contact massage device, comprising:
a control and adjustment part; and
a working part interconnected to the control and adjustment part,
wherein the working part includes
a robotic articulated actuator,
a damping suspension system, and
a sensitive contact element for a massage effect,
wherein the robotic articulated actuator includes movably interconnected links with non-coaxial transitions in their connection points,
wherein the damping suspension system includes a support bracket mounted on a free end of the interconnected links,
wherein the support bracket includes a linear vertically oriented guide mounted thereon, the guide having a movable carriage mounted thereon,
wherein movement of the carriage in an upper direction is limited by a connecting module with an elastic element mounted on a connecting part of the support bracket,
wherein the carriage includes a retaining unit with the sensitive contact element mounted thereon,
wherein the sensitive contact element is located so that a plane formed by a contact part of the sensitive contact element with a user's body is substantially perpendicular to the linear guide.

9. The massage device of claim 8, wherein the sensitive contact element includes a plurality of spherical elements for vibrocompression massage.
